(19) United States
(12) Patent Application Publication
(10) Pub. No.: US 2009/0094842 A1
(43) Pub. Date: Apr. 16, 2009

(54) Device for Opening Envelopes

(75) Inventor: Dae Kyu Yoo, Gyeonggi-do (KR)

Correspondence Address: DICKSTEIN SHAPIRO LLP, 1825 EYE STREET NW, Washington, DC, 20006-5403, US

(73) Assignee: RASS ITS CORPORATION, Gyeonggi-do (KR)

(21) Appl. No.: 11/920,058

(22) PCT Filed: May 3, 2006
(86) PCT No.: PCT/KR2006/001675

§ 371 Date: Nov. 8, 2007

(30) Foreign Application Priority Data
May 12, 2005 (KR) 10-2005-0039622

(51) Int. Cl. B26B 29/00; B26B 29/06

(52) U.S. Cl. 30/290; 30/294; 30/289

(57) ABSTRACT

A device for opening an envelope is disclosed. In the envelope opening device of the present invention, when a user merely inserts an edge part of an envelope into a guide slot of a casing and pushes or pulls the envelope, the edge part of the envelope is precisely cut by a cutting means to a predetermined length while the edge part is supported and guided by a guide wall, which is provided inside the guide slot, and while the envelope is held and supported by a holding means such that it is prevented from undesirably moving. Therefore, the present invention makes it possible to precisely cut the edge part of the envelope to a minimum length. Furthermore, because the present invention does not require the user to pay much attention to the length of the edge part to be cut, there is an advantage in that the opening process is simplified.

### TECHNICAL FIELD

The present invention relates, in general, to devices for opening envelopes and, more particularly, to an envelope opening device which makes it possible for a user to easily open an envelope.

### BACKGROUND ART

Generally, to open envelopes, such as letter envelopes, paper envelopes and vinyl envelopes, users mainly detach sealed parts from the envelopes or cut edge parts of the envelopes.

However, it is often difficult to detach a sealed part from an envelope because glue is applied over a wide range. Therefore, the method of cutting an edge part of the envelope is used in general.

To cut the edge part of the envelope, a user carefully pulls and tears off the edge part of the envelope using his/her hands or cuts the edge part using scissors or a knife.

### DISCLOSURE OF INVENTION

### Technical Problem

When cutting the edge part of the envelope, the edge part must be cut to a minimum length to prevent the contents in the envelope from being cut along with the edge part. However, due to the characteristics of imprecise manual work using hands or a cutting tool, the edge part is usually roughly cut from the envelope. As such, because it is difficult to precisely cut the edge part, there is a problem in that the contents of the envelope may be cut along with the edge part of the envelope.

Furthermore, in the case that there are several envelopes that must be opened, because the user must carefully cut the edge part of every one of the envelopes, it is very inconvenient.

Accordingly, to resolve the above problems occurring in the prior art, and an object of the present invention is to provide an envelope opening device which can precisely cut an edge part of an envelope to a minimum length and does not require the user to pay much attention to the length of the edge part to be cut, thus simplifying the opening process.

### Technical Solution

In order to accomplish the above object, the present invention provides a device for opening an envelope, including: a casing, with a guide slot formed with a long groove at one side of the casing; a guide wall longitudinally formed with a long groove inside the guide slot in the casing to support and guide an edge of the envelope inserted into the guide slot; a cutting means provided inside the guide slot in the casing at a position spaced apart from the guide wall towards the guide slot by a predetermined distance; and a holding means provided inside the guide slot in the casing and compressing opposite surfaces of the envelope inserted into the guide slot while rotating in response to linear movement of the envelope.

Furthermore, the cutting means may include: a pair of rotating shafts provided at upper and lower positions of the guide slot so as to be rotatable; and a pair of rotating cutters provided on the respective rotating shafts and rotating while facing surfaces of edge parts thereof contact each other.

The holding means may include: a pair of rotating shafts provided at upper and lower positions of the guide slot so as to be rotatable; and a pair of rollers coupled to the respective rotating shafts such that circumferential outer surfaces thereof face each other.

The device for opening the envelope may further include a gear means coupling the rotating shafts of the cutting means to the rotating shafts of the holding means such that the rotating shafts of the cutting means and the rotating shafts of the holding means are operated in conjunction with each other.

### ADVANTAGEOUS EFFECTS

In the present invention, when a user merely inserts an edge part of an envelope into a guide slot of a casing and then pushes or pulls the envelope, the edge part of the envelope is precisely cut to a predetermined length by a cutting means while the edge part is supported and guided by a guide wall, which is provided inside the guide slot in the casing, and while the envelope is held and supported by a holding means such that it does not move undesirably.

Therefore, the present invention makes it possible to precisely cut the edge part of the envelope to a minimum length. Furthermore, because the present invention does not require the user to pay much attention to length of the edge part to be cut, there is an advantage in that the opening process is simplified.

As well, since neither separate electric power nor a drive means are required. A separate battery or power cord are not required either. Hence, the internal structure is simplified, and manufacturing costs are markedly reduced.

### BRIEF DESCRIPTION OF THE DRAWINGS

FIG. 1 is a perspective view showing the external shape of a device for opening envelopes, according to a preferred embodiment of the present invention;

FIG. 2 is a sectional view taken along the line A-A of FIG. 1;

FIG. 3 is a perspective view showing an enlargement of critical parts of FIG. 2;

FIG. 4 is a view showing a modification of some parts of FIG. 3; and

FIG. 5 is a view showing the operation of the device for opening envelopes, according to the preferred embodiment of the present invention.

### MODE FOR THE INVENTION

Hereinafter, a preferred embodiment of the present invention will be described in detail with reference to the attached drawings.

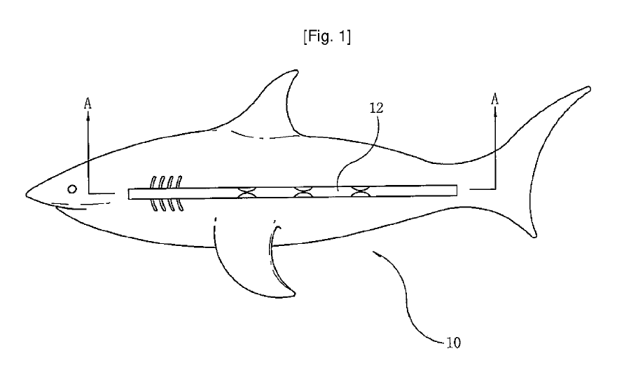

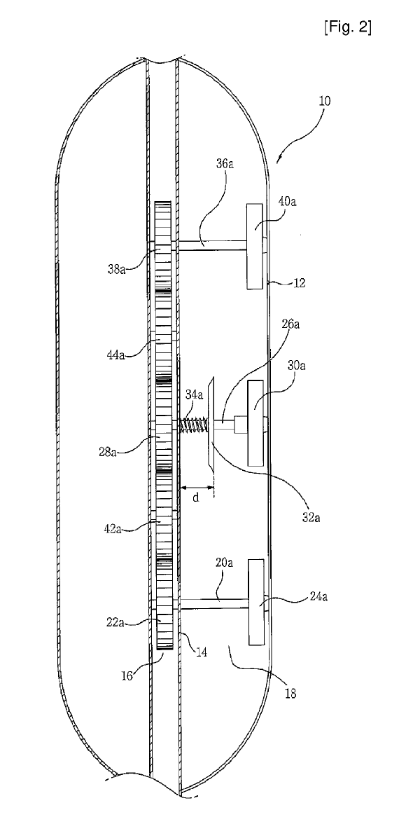

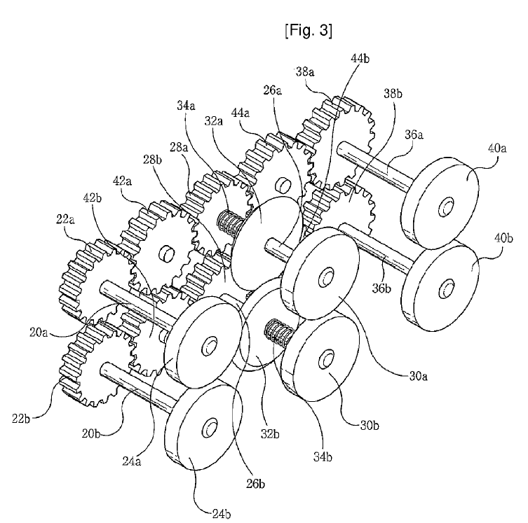

FIG. 1 is a perspective view showing the external shape of a device for opening envelopes, according to the preferred embodiment of the present invention. FIG. 2 is a sectional view taken along the line A-A of FIG. 1. FIG. 3 is a perspective view showing an enlargement of critical parts of FIG. 2.

Referring to FIGS. 1 to 3, the envelope opening device according to the preferred embodiment of the present invention includes a casing 10, in which a guide slot 12, is formed with a long groove at one side. A guide wall 14, which supports an edge of an envelope inserted into the guide slot 12 and guides it in the longitudinal direction of the guide slot 12, is longitudinally formed with a long groove inside the guide slot 12 in the casing 10.

The internal space of the casing 10 is partitioned into a first receiving space 16 and a second receiving space 18 by the guide wall 14. A holding means and a cutting means are provided in the second receiving space 18, and a gear means is provided in the first receiving space 16.

The holding means includes a pair of first rotating shafts 20a and 20b, a pair of second rotating shafts 26a and 26b and a pair of third rotating shafts 36a and 36b, which are disposed at upper and lower positions of the opening of the guide slot 12 and are rotatably provided through the guide wall 14. The pair of first rotating shafts 20a and 20b, the pair of second rotating shafts 26a and 26b and the pair of third rotating shafts 36a and 36b are spaced apart from each other at preset intervals in the longitudinal direction of the guide slot 12.

The holding means further includes a pair of first rollers 24a and 24b, which are respectively coupled to first ends of the pair of first rotating shafts 20a and 20b and disposed such that the circumferential surfaces thereof face each other, and a pair of second rollers 30a and 30b, which are respectively coupled to first ends of the second rotating shafts 26a and 26b and disposed such that the circumferential surfaces thereof face each other. The holding means further includes a pair of third rollers 40a and 40b, which are respectively coupled to first ends of the pair of third rotating shafts 36a and 36b and disposed such that the circumferential surfaces thereof face each other.

Here, the rollers 24a, 24b, 30a, 30b, 40a and 40b serve to compress and hold opposite surfaces of the envelope to be inserted into the guide slot 12. Preferably, at least the circumferential part of each roller 24a, 24b, 30a, 30b, 40a, 40b that contacts the opposite surfaces of the envelope is made of a material, such as rubber, that has a high frictional coefficient. Furthermore, the entire body of each roller 24a, 24b, 30a, 30b, 40a, 40b is preferably made of a material, such as rubber, that has a high frictional coefficient.

The cutting means includes a pair of rotating cutters 32a and 32b, which are respectively coupled to the circumferential outer surfaces of the pair of second rotating shafts 26a and 26b at positions spaced apart from the guide wall 14 towards the opening of the guide slot 12 by predetermined distances (d) and are provided such that they rotate while facing surfaces of cutting edges thereof contact each other. The cutting means further includes a pair of elastic members 34a and 34b, which impart elasticity to respective rotating cutters 32a and 32b, thus increasing contacting force between the rotating cutters 32a and 32b.

Here, the elastic member 34a is fitted over the rotating shaft 26a between the guide wall 14 and the rotating cutter 32a. The elastic member 34b is fitted over the rotating shaft 26b between the rotating cutter 32b and the roller 30b. Therefore, the elastic members 34a and 34b respectively and elastically support the rotating cutters 32a and 32b in directions facing each other.

For reference, because the cutting edges of the pair of rotating cutters 32a and 32b are in close contact with each other when they are rotated, wear occurs with the passage of time so that a gap may be formed therebetween. However, in the present invention, because the elastic members 34a and 34b elastically support the rotating cutters 32a and 32b in directions facing each other, a gap is prevented from occurring between the rotating cutters 32a and 32b due to wear.

The gear means includes a pair of first direct coupled gears 22a and 22b, a pair of second direct coupled gears 28a and 28b and a pair of third direct coupled gears 38a and 38b, which are respectively coupled to other ends of the pair of first rotating shafts 20a and 20b, the pair of second rotating shafts 26a and 26b and the third pair of rotating shafts 36a and 36b.

The gear means further includes an idle gear 42a, which engages with the direct coupled gears 22a and 28a therebetween, and an idle gear 44a, which engages with the direct coupled gears 28a and 38a therebetween. The gear means further includes an idle gear 42b, which engages with the direct coupled gears 22b and 28b therebetween, and an idle gear 44b, which engages with the direct coupled gears 28b and 38b therebetween.

The gear means having the above-mentioned construction makes the rollers 24a, 30a and 40a and the rotating cutter 32a to operate in conjunction with each other. Furthermore, the gear means makes the rollers 24b, 30b and 40b to operate in conjunction with each other.

For reference, even if the rollers and the rotating cutters are not operated in conjunction with each other, the purpose of the present invention can be achieved. When a user inserts the envelope into the guide slot 12 and pulls it in the longitudinal direction of the guide slot 12, the rollers 24a, 24b, 30a, 30b, 40a and 40b and the rotating cutters 32a and 32b are rotated because they are in contact with the envelope. At this time, the rollers 24a, 24b, 30a, 30b, 40a and 40b hold the envelope such that it is prevented from being undesirably removed or from moving and help the advance of the envelope, while the rotating cutters 32a and 32b cut the edge part of the envelope. Therefore, even if the gear means is not provided, the purpose of the present invention can be achieved.

However, if the rollers 24a, 24b, 30a, 30b, 40a and 40b and the rotating cutters 32a and 32b are operated in conjunction with each other through the gear means, because the pulling force of the user is transmitted from the rollers 24a, 24b, 30a, 30b, 40a and 40b to the rotating cutters 32a and 32b when the user pulls it in the longitudinal direction of the guide slot 12 after inserting the envelope into the guide slot 12, the rotating cutters 32a and 32b are rotated by a strong force. Accordingly, the envelope can be cut easily.

In this embodiment of the present invention, the gear means is constructed such that the rotating cutters 32a and 32b and the rollers 24a, 24b, 30a, 30b, 40a and 40b have a gear ratio of 1:1 so that they are rotated in the same number of revolutions, but the gear ratio may be preset to a different value.

For example, the gear ratio of the gear means may be preset to 1:1.5 to 2, so that the rotating cutters 32a and 32b male 1.5 to 2 revolutions while the first rollers 24a and 24b and the third rollers 40a and 40b make one revolution. Here, in the case that the gear ratio is preset such that the number of revolutions of the rotating cutters 32a and 32b is greater than that of the rollers, the second rollers 30a and 30b must rotate independent of the rotating cutters 32a and 32b (for example, a) the second rollers may be provided on separate rotating shafts which are not the same rotating shafts as those of the rotating cutters, or, b) the second rollers are provided on the same rotating shafts as those of the rotating cutters, but the second rollers are rotatable with no relation to the rotating shafts and are constructed such that the second rollers are rotated in conjunction with other rollers through separate gears).

In the case that the gear ratio of the gear means is preset to 1:1.5 to 2 such that the rotating cutters 32a and 32b make 1.5 to 2 revolutions while the first rollers 24a and 24b and the third rollers 40a and 40b make one revolution, because the rotating cutters 32 and 32b are rotated at higher speed, the edge part of the envelope can be cut more easily.

A change in the gear ratio of the gear means can be easily conducted by changing the number of gear teeth, and because this is a well known technique, further explanation is deemed unnecessary.

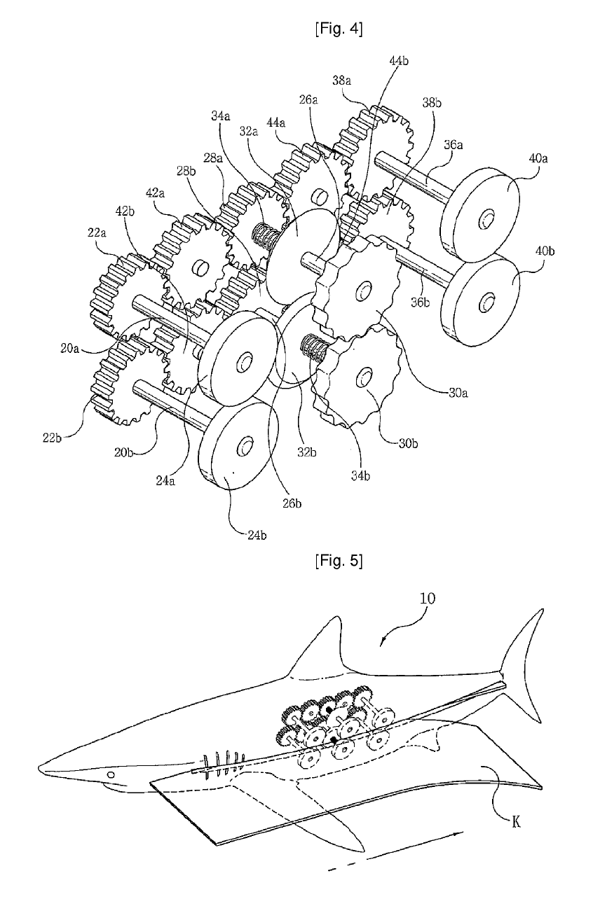

Meanwhile, FIG. 4 shows a construction in which second rollers 30a and 30b, which are respectively provided on the same rotating shafts 26a and 26b as those of the rotating cutters 32a and 32b, have a plurality of prominences and depressions on the circumferential outer surfaces thereof, and the prominences and depressions of the second rollers 30a and 30b engage with each other so that an envelope can be held more reliably.

As required, prominences and depressions may be provided not only on the second rollers 30a and 30b but also on other rollers, that is, the first rollers 24a and 24b or the third rollers 40a and 40b.

The operation and effects of the envelope opening device according to the preferred embodiment of the present invention having the above-mentioned construction will be described herein below.

As shown in FIG. 5, the user inserts a desired edge part of the envelope (K) into the guide slot 12 of the casing 10 through one end of the guide slot 12. Thereafter, the user pushes or pulls the envelope (K) in the longitudinal direction of the guide slot 12, that is, in the direction indicated by the arrow. Here, it is necessary to insert the envelope (K) through the guide slot 12 to a sufficient depth until it contacts the guide wall 14 provided inside the guide slot 12. Then, the edge of the envelope (K) can be reliably supported by the guide wall 14.

While the envelope (K) proceeds, the opposite surfaces of the envelope (K) are held between the first rollers 24a and 24b, the second rollers 30a and 30b, or the third rollers 40a and 40b. The first rollers 24a and 24b, the second rollers 30a and 30b, or the third rollers 40a and 40b are rotated in directions determined by the moving direction of the envelope (K). At this time, they help the motion of the envelope (K), maintain the level state of the envelope (K), and hold the envelope (K) using friction of the circumferential outer surfaces thereof to prevent the envelope (K) from undesirably moving (in the direction from the guide wall 14 towards the guide slot 12) and from being removed.

As such, thanks to the holding operation of the rollers 24a, 24b, 30a, 30b, 40a and 40b, a gap is prevented from occurring between the edge of the envelope (K) and the guide wall 14 and, as well, the envelope (K) is prevented from being undesirably removed. Therefore, the process can be conducted when the user merely pushes or pulls the envelope (K) without paying particular attention, thus being convenient for the user.

Furthermore, the edge part of the envelope (K), which is held by the rollers 24a, 24b, 30a, 30b, 40a and 40b and is moved along the guide slot 12, is inserted between the rotating cutters 32a and 32b. The rotating cutters 32a and 32b are rotated in opposite directions by the movement of the envelope (K) and thus cut the edge part of the envelope (K).

Here, because the envelope (K) is guided by the guide wall 14 and held by the rollers 24a, 24b, 30a, 30b, 40a and 40b when it advances, the edge part of the envelope (K) is cut to a width equal to the preset distance (d) defined between the guide wall 14 and the rotating cutters 32a and 32b. Therefore, the contents of the envelope (K) are prevented from being cut along with the edge part of the envelope (K).

Meanwhile, as described above, if the envelope opening device is constructed such that the rollers 24a, 24b, 30a, 30b, 40a and 40b and the rotating cutters 32a and 32b are operated in conjunction with each other through the gear means, when the user inserts the envelope (K) into the guide slot 12 and moves it, because the force of the user is transmitted to the rotating cutters 32a and 32b through the rollers 24a, 24b, 30a, 30b, 40a and 40b, the rotating cutters 32a and 32b are rotated by the stronger force. Therefore, the edge part of the envelope (K) can be cut more easily.

As such, in the present invention, the edge part of the envelope (K) is cut by rotating the rotating cutters 32a and 32b using the force transmitted from the user thereto through the rollers 24a, 24b, 30a, 30b, 40a and 40b when the user moves the envelope (K) along the guide slot 12 after inserting it into the guide slot 12. Therefore, a separate electric power and a separate drive means are not required. A battery or a power cord is not required either. Hence, the internal structure is simplified, and manufacturing costs are markedly reduced.

Furthermore, in the present invention, the gear ratio of the gear means may be preset to 1:1.5 to 2 such that the rotating cutters 32a and 32b make 1.5 to 2 revolutions while the first rollers 24a and 24b and the third rollers 40a and 40b make one revolution. In this case, because the rotating cutters 32 and 32b are rotated at higher speed, the edge part of the envelope (K) can be cut more easily. As such, in the case that the gear ratio of the gear means is preset such that the number of revolutions of the rotating cutters 32a and 32b is greater than that of the rollers, it is required that the rotation of the second rollers 30a and 30b are made independent of the rotation of the rotating cutters 32a and 32b (for example, a) the second rollers may be provided on separate rotating shafts which are not the same rotating shafts as those of the rotating cutters, or, b) the second rollers are provided on the same rotating shafts as those of the rotating cutters, but the second rollers are rotatable with no relation to the rotating shafts and are constructed such that the second rollers are rotated in conjunction with other rollers through separate gears).

Although the preferred embodiment of the present invention has been disclosed for illustrative purposes, the present invention is not limited to this. Furthermore, those skilled in the art will appreciate that various modifications, additions and substitutions are possible, and theses modifications, additions and substitutions fall within the bounds of the present invention as long as they use the characteristics of the present invention.

1. A device for opening an envelope, comprising:
a casing, with a guide slot formed with a long groove at one side of the casing;
a guide wall longitudinally formed with a groove inside the guide slot in the casing to support and guide an edge of the envelope inserted into the guide slot;
cutting means provided inside the guide slot in the casing at a position spaced apart from the guide wall towards an opening of the guide slot by a predetermined distance; and
holding means provided inside the guide slot in the casing and compressing opposite surfaces of the envelope inserted into the guide slot while rotating in response to linear movement of the envelope.

2. The device for opening the envelope according to claim 1, wherein the cutting means comprises: a pair of rotating shafts provided at upper and lower positions of the opening of the guide slot so as to be rotatable; and a pair of rotating cutters provided on the respective rotating shafts and rotating while facing surfaces of edge parts thereof contact each other.

3. The device for opening the envelope according to claim 2, wherein the cutting means further comprises: a pair of elastic members fitted over the respective rotating shafts and elastically supporting the respective rotating cutters in directions facing each other.

4. The device for opening the envelope according to claim 2, wherein the holding means comprises: a pair of rotating shafts provided at upper and lower positions of the opening of the guide slot so as to be rotatable; and a pair of rollers coupled to the respective rotating shafts and disposed such that circumferential outer surfaces thereof face each other.

5. The device for opening the envelope according to claim 4, further comprising: gear means by which the rotating shafts of the cutting means and the rotating shafts of the holding means are operated in conjunction with each other.

6. The device for opening the envelope according to claim 5, wherein the gear means has a gear ratio preset such that a rotating speed of the rotating shafts of the cutting means is faster than a rotating speed of the rotating shafts of the holding means.

7. The device for opening the envelope according to claim 1, wherein the holding means comprises: a pair of rotating shafts provided at upper and lower positions of the opening of the guide slot; and a pair of rollers coupled to the respective rotating shafts such that circumferential outer surfaces thereof face each other.

8. The device for opening the envelope according to claim 1, wherein the holding means are in plurality, and the holding means are provided along a longitudinal direction of the guide slot.

9. The device for opening the envelope according to claim 4, wherein the holding means are in plurality, and the holding means are provided along a longitudinal direction of the guide slot.

10. The device for opening the envelope according to claim 7, wherein the holding means are in plurality, and the holding means are provided along a longitudinal direction of the guide slot.

11. The device for opening the envelope according to claim 1, wherein each of the rollers of the holding means is made of rubber at least at a circumferential outer surface thereof.

12. The device for opening the envelope according to claim 4, wherein each of the rollers of the holding means is made of rubber at least at a circumferential outer surface thereof.

13. The device for opening the envelope according to claim 7, wherein each of the rollers of the holding means is made of rubber at least at a circumferential outer surface thereof.

14. The device for opening the envelope according to claim 11, wherein each of the rollers of the holding means has a plurality of prominences and depressions on the circumferential outer surface thereof.

15. The device for opening the envelope according to claim 12, wherein each of the rollers of the holding means has a plurality of prominences and depressions on the circumferential outer surface thereof.

16. The device for opening the envelope according to claim 13, wherein each of the rollers of the holding means has a plurality of prominences and depressions on the circumferential outer surface thereof.

17. The device for opening the envelope according to claim 1, wherein the cutting means comprises a rotating cutter, the device further comprising:
gear means coupling the rotating cutter of the cutting means to the holding means such that the rotating cutter of the cutting means and the holding means are rotated in conjunction with each other.

18. The device for opening the envelope according to claim 17, wherein the gear means has a gear ratio preset such that a rotating speed of the rotating cutter of the cutting means is faster than a rotating speed of the holding means.
